(19) United States
(12) Patent Application Publication
(10) Pub. No.: US 2020/0042321 A1
(43) Pub. Date: Feb. 6, 2020

(54) LOW POWER BACK-TO-BACK WAKE UP AND ISSUE FOR PAIRED ISSUE QUEUE IN A MICROPROCESSOR

(71) Applicant: INTERNATIONAL BUSINESS MACHINES CORPORATION, ARMONK, NY (US)

(72) Inventors: Michael J. Genden, Ausin, TX (US); Hung Q. Le, Austin, TX (US); Dung Q. Nguyen, Austin, TX (US); Brian W. Thompto, Austin, TX (US)

(21) Appl. No.: 16/051,380

(22) Filed: Jul. 31, 2018

(51) Int. Cl. G06F 9/38

(52) U.S. Cl. CPC G06F 9/3838; G06F 9/3824; G06F 9/3885

(57) ABSTRACT

An apparatus for back-to-back wakeup and issue of paired instructions is disclosed includes a paired dependency module that identifies that a dependent source of a younger instruction is a result of an older instruction. The older instruction and the younger instruction include paired instructions in a double issue queue of a processor. The apparatus includes a wakeup bit circuit that sets a wakeup bit corresponding to the dependent source of the younger instruction that is dependent on the results of the older instruction in response to the paired dependency module identifying that a dependent source of the younger instruction is a result of the older instruction and the older instruction being issued. The wakeup bit circuit sets the wakeup bit in a same clock cycle as the older instruction issues.

### BACKGROUND

The subject matter disclosed herein relates to queuing of instructions in a processor and more particularly relates to issuing paired instructions back-to-back when a younger instruction of the pair is dependent on an older instruction of the pair.

A processor or core of a processor often include multiple execution slices that enable parallel processing of commands. The commands are compiled into instructions and a dispatcher sends instructions to an execution slice for processing. The instructions are processed by a mapper that tracks operations and data of an instruction and places the instructions in an issue queue, which verifies operands and other data inputs are available before execution of the instructions. In some cases, the mapper places instructions in a double issue queue where instructions can be paired in a row, which often is more efficient than a single-wide issue queue. For paired instructions where one instruction is dependent on the other instruction, the instruction that is the dependent source (“older instruction”) must issue before the other younger instruction. Currently there is a delay between issuance of the paired instructions of a few clock cycles.

### SUMMARY

An apparatus for back-to-back wakeup and issue of paired instructions is disclosed. A computer-implemented method and processor also perform the functions of the apparatus. According to an embodiment of the present invention, the apparatus includes a paired dependency module that identifies that a dependent source of a younger instruction is a result of an older instruction. The older instruction and the younger instruction include paired instructions in a double issue queue of a processor. The apparatus includes a wakeup bit circuit that sets a wakeup bit corresponding to the dependent source of the younger instruction that is dependent on the results of the older instruction in response to the paired dependency module identifying that a dependent source of the younger instruction is a result of the older instruction and the older instruction being issued. The wakeup bit circuit sets the wakeup bit in a same clock cycle as the issue of the older instruction.

A processor for back-to-back wakeup and issue of paired instructions includes a double issue queue sized for paired instructions. Each paired instructions includes an older instruction and a younger instruction. The double issue queue includes a plurality of source wakeup selection bits, where each source wakeup selection bit corresponds to an available dependent source of the younger instruction, and a plurality of wakeup bits, where each wakeup bit corresponds to an available dependent source of the younger instruction. The wakeup bit corresponding to a dependent source indicates that results of the dependent source are available. The processor includes a dispatcher that identifies that a dependent source of the younger instruction is a result of the older instruction, identifies which dependent source of the available dependent sources of the younger instruction is dependent on the results of execution of the older instruction, and sets a source wakeup selection bit of the plurality of source wakeup selection bits corresponding to the dependent source of the younger instruction. The processor includes an issue multiplexer corresponding to each dependent source of the younger instruction. The issue multiplexer corresponding to the dependent source of the younger instruction that is a result of the older instruction sets the wakeup bit corresponding to the dependent source of the younger instruction that is dependent on the results of the older instruction in response to the source wakeup selection bit corresponding to the dependent source of the younger instruction that is a result of the older instruction being set and the older instruction being issued.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for back-to-back wakeup and issue of paired instructions;

FIG. 2 is a schematic block diagram illustrating one embodiment of a processor for back-to-back wakeup and issue of paired instructions;

FIG. 3 is a schematic block diagram illustrating a portion of a row of a double issue queue with paired instructions and associated circuitry for back-to-back wakeup and issue of the paired instructions;

FIG. 4 is a schematic flow chart diagram illustrating one embodiment of a method for back-to-back wakeup and issue of paired instructions; and

FIG. 5 is a schematic flow chart diagram illustrating one embodiment of another method for back-to-back wakeup and issue of paired instructions.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. The modules or portions of modules need not be physically located together, but may comprise disparate components in different locations which, when joined logically together, comprise the module and achieve the stated purpose for the module.

One skilled in the relevant art will recognize that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

An apparatus for back-to-back wakeup and issue of paired instructions is disclosed. A computer-implemented method and processor also perform the functions of the apparatus. According to an embodiment of the present invention, the apparatus includes a paired dependency module that identifies that a dependent source of a younger instruction is a result of an older instruction. The older instruction and the younger instruction include paired instructions in a double issue queue of a processor. The apparatus includes a wakeup bit circuit that sets a wakeup bit corresponding to the dependent source of the younger instruction that is dependent on the results of the older instruction in response to the paired dependency module identifying that a dependent source of the younger instruction is a result of the older instruction and the older instruction being issued. The wakeup bit circuit sets the wakeup bit in a same clock cycle as the issue of the older instruction.

In some embodiments, the double issue queue includes a plurality of source wakeup selection bits, where each source wakeup selection bit corresponds to an available dependent source of the younger instruction, and the double issue queue includes a plurality of wakeup bits, where each wakeup bit corresponds to an available dependent source of the younger instruction. The wakeup bit corresponding to a dependent source indicates that results of the dependent source are available.

In other embodiments, identifying that a dependent source of a younger instruction is a result of an older instruction includes identifying which dependent source of the available dependent sources of the younger instruction is dependent on the results of execution of the older instruction, and setting a source wakeup selection bit of the plurality of source wakeup selection bits corresponding to the dependent source of the younger instruction. In the embodiment, the wakeup bit circuit sets the wakeup bit corresponding to the dependent source of the younger instruction that is dependent on the results of the older instruction in response to the source wakeup selection bit corresponding to the dependent source of the younger instruction being set and the older instruction being issued. In other embodiments, the wakeup bit circuit includes an issue multiplexer that sets the wakeup bit corresponding to the dependent source of the younger instruction that is dependent on the results of the older instruction in response to the source wakeup selection bit corresponding to the dependent source of the younger instruction being set and the older instruction being issued.

In some embodiments, the wakeup bit circuit sets a wakeup bit corresponding to a dependent source of the younger instruction in response to the paired dependency module identifying that the dependent source of the younger instruction is a result of the older instruction and the older instruction being issued or a dependency tracker identifying that results of a dependent source corresponding to the dependent source wakeup bit of the younger instruction are available. In other embodiments, the wakeup bit circuit sets the wakeup bit corresponding to the dependent source of the younger instruction that is dependent on the results of the older instruction prior to a dependency tracker setting the wakeup bit after identifying that the results of the older instruction are available.

In other embodiments, the apparatus includes an execution unit that executes the older instruction in a first clock cycle and that executes the younger instruction in a second clock cycle in response to the wakeup bit circuit setting the wakeup bit corresponding to the dependent source of the younger instruction that is dependent on the results of the older instruction, where the second clock cycle is immediately after the first clock cycle. In other embodiments, the paired dependency module is part of a dispatcher and the dispatcher places the paired instructions in the double issue queue.

A computer-implemented method for back-to-back wakeup and issue of paired instructions includes identifying that a dependent source of a younger instruction is a result of an older instruction, where the older instruction and the younger instruction are paired instructions in a double issue queue of a processor. The computer-implemented method includes setting, in a same clock cycle as the older instruction issues, a wakeup bit corresponding to the dependent source of the younger instruction that is dependent on the results of the older instruction in response to identifying that a dependent source of the younger instruction is a result of the older instruction and the older instruction being issued.

In some embodiments, the double issue queue includes a plurality of source wakeup selection bits, where each source wakeup selection bit corresponds to an available dependent source of the younger instruction, and includes a plurality of wakeup bits, where each wakeup bit corresponds to an available dependent source of the younger instruction. The wakeup bit corresponding to a dependent source indicates that results of the dependent source are available. In other embodiments, identifying that a dependent source of a younger instruction is a result of an older instruction includes identifying which dependent source of the available dependent sources of the younger instruction is dependent on the results of execution of the older instruction and setting a source wakeup selection bit of the plurality of source wakeup selection bits corresponding to the dependent source of the younger instruction. Setting the wakeup bit corresponding to the dependent source of the younger instruction that is dependent on the results of the older instruction is in response to the source wakeup selection bit corresponding to the dependent source of the younger instruction being set and the older instruction being issued.

In some embodiments, setting a wakeup bit corresponding to a dependent source of the younger instruction is in response to identifying that the dependent source of the younger instruction is a result of the older instruction and the older instruction being issued or identifying that results of a dependent source corresponding to the dependent source wakeup bit of the younger instruction are available. In other embodiments, setting the wakeup bit corresponding to the dependent source of the younger instruction that is dependent on the results of the older instruction occurs prior to a dependency tracker setting the wakeup bit after identifying that the results of the older instruction are available.

In some embodiments, the computer-implemented method includes executing the older instruction in a first clock cycle and executing the younger instruction in a second clock cycle in response to setting the wakeup bit corresponding to the dependent source of the younger instruction that is dependent on the results of the older instruction, where the second clock cycle is immediately after the first clock cycle. In other embodiments, identifying that a dependent source of a younger instruction is a result of an older instruction occurs in a dispatcher or a mapper, where the dispatcher places the paired instructions in the double issue queue and the mapper maps each instruction with a register that stores results of the instruction.

A processor for back-to-back wakeup and issue of paired instructions includes a double issue queue sized for paired instructions. Each paired instructions includes an older instruction and a younger instruction. The double issue queue includes a plurality of source wakeup selection bits, where each source wakeup selection bit corresponds to an available dependent source of the younger instruction, and a plurality of wakeup bits, where each wakeup bit corresponds to an available dependent source of the younger instruction. The wakeup bit corresponding to a dependent source indicates that results of the dependent source are available. The processor includes a dispatcher that identifies that a dependent source of the younger instruction is a result of the older instruction, identifies which dependent source of the available dependent sources of the younger instruction is dependent on the results of execution of the older instruction, and sets a source wakeup selection bit of the plurality of source wakeup selection bits corresponding to the dependent source of the younger instruction. The processor includes an issue multiplexer corresponding to each dependent source of the younger instruction. The issue multiplexer corresponding to the dependent source of the younger instruction that is a result of the older instruction sets the wakeup bit corresponding to the dependent source of the younger instruction that is dependent on the results of the older instruction in response to the source wakeup selection bit corresponding to the dependent source of the younger instruction that is a result of the older instruction being set and the older instruction being issued.

In some embodiments, the processor includes an OR gate for each wakeup bit of the younger instruction. The OR gate of a wakeup bit sets the wakeup bit in response to a dependency tracker corresponding to the wakeup bit identifying that results of a dependent source corresponding to the wakeup bit of the younger instruction are available or the issue multiplexer of the dependent source identifying that the source wakeup selection bit corresponding to the dependent source of the younger instruction that is a result of the older instruction being set and the older instruction being issued. In other embodiments, the issue multiplexer corresponding to the dependent source of the younger instruction that is a dependent source of the older instruction sets the wakeup bit corresponding to the dependent source of the younger instruction that is dependent on the results of the older instruction prior to a dependency tracker setting the wakeup bit after identifying that the results of the older instruction are available.

In other embodiments, the processor includes an execution unit that executes the older instruction in a first clock cycle and that executes the younger instruction in a second clock cycle in response to the issue multiplexer setting the wakeup bit corresponding to the dependent source of the younger instruction that is dependent on the results of the older instruction, where the second clock cycle is immediately after the first clock cycle.

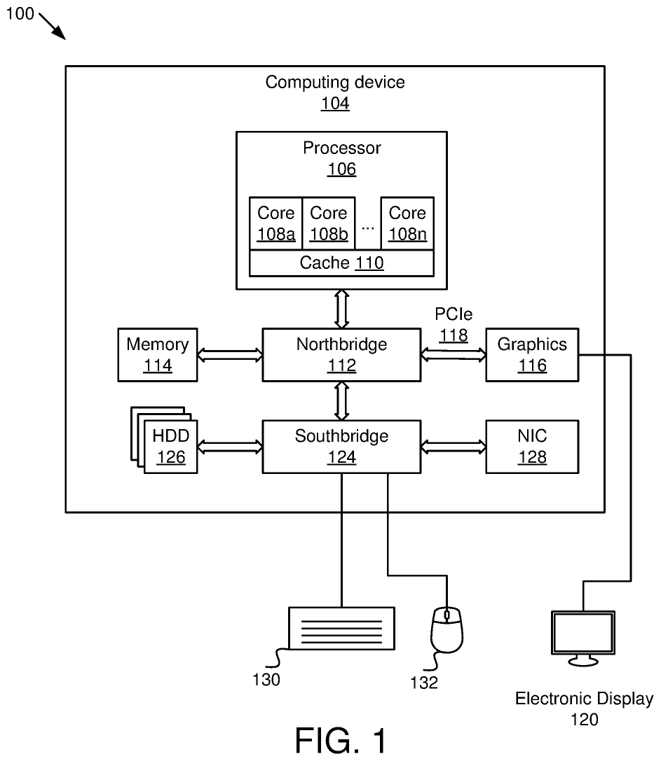

FIG. 1 is a schematic block diagram illustrating one embodiment of a system 100 for back-to-back wakeup and issue of paired instructions. A pair-based issue queue may also be called a double issue queue and the terms are used interchangeably herein. The system 100 includes a computing device 104 with a processor 106 with N cores 108a, 108b, . . . 108n and cache 110, a northbridge 112, memory 114, a graphics card 116, connected over a peripheral component interconnect express (“PCIe”) bus 118, an electronic display 120, a southbridge 124, hard disk drives 126, a network interface card (“NIC”) 128, a keyboard 130, and a mouse 132, which are described below.

The system 100 includes a computing device 104, which may be a desktop computer, a laptop computer, a tablet computer, a workstation, a mainframe computer, a smartphone, a fitness tracking device, a game controller, or other computing device with a processor 106. The computing device 104 includes a processor 106 that includes one or more cores 108a, 108b . . . 108n (collectively or generically “108”) and corresponding cache 110. The processor 106, in some embodiments, may be referred to as a central processing unit (“CPU”). In other embodiments, each core 108 may be called a CPU. In some embodiments, the computing device 104 may include a baseboard management controller (“BMC”) (not shown) or a similar device to manage each core, virtual machines, loading, and other functions known to those in the art. The computing device 104 may include a northbridge 112 that connects to memory 114 over a memory bus. A graphics card 116 may connect to the northbridge 112 through a PCIe bus 118 and may drive an electronic display 120. The electronic display 120 may be separate or may be integrated with the computing device 104 and may be a touch screen I/O device.

The southbridge 124 is connected to the northbridge 112 and may connect to various devices, such as hard disk drives (“HDD”) 126, a network interface card (“NIC”) 128, a keyboard 130, a mouse 132, a microphone, a camera, speakers and the like. Note that other non-volatile storage devices may be in or connected to the computing device 104, such as a solid-state drive (“SSD”) which may be in addition to or in place of the hard disk drives 126. The keyboard 130, mouse 132, microphone, camera, electronic display 120, stylus (not shown), etc. are typical I/O devices that are capable of receiving input from a user to control the computing device 104. Speakers and electronic display 120 are typical I/O devices that receive signals from the computing device 104 to provide output to a user as feedback for commands and other input from the user input through the keyboard 130, mouse 132, microphone, etc.

In some embodiments, the computing device 104 connects to other devices over a computer network through the network interface card (“NIC”) 128. The computer network may be a local area network (“LAN”), a wide area network (“WAN”), the Internet, a wireless network, etc. and may include two or more networks. The computer network includes typical network hardware, such as routers, switches, servers, cabling, and the like.

The wireless network may be a mobile telephone network. The wireless network may also employ a Wi-Fi network based on any one of the Institute of Electrical and Electronics Engineers (“IEEE”) 802.11 standards. Alternatively, the wireless network may be a BLUETOOTH® connection or a near-field communication (“NFC”) connection. In addition, the wireless network may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless network may employ a ZigBee® connection based on the IEEE 802 standard. In one embodiment, the wireless network employs a Z-Wave® connection as designed by Sigma Designs®. Alternatively, the wireless network may employ an ANT® and/or ANT+® connection as defined by Dynastream® Innovations Inc. of Cochrane, Canada. The wireless network may be an infrared connection including connections conforming at least to the Infrared Physical Layer Specification (“IrPHY”) as defined by the Infrared Data Association® (“IrDA”®). Alternatively, the wireless network may be a cellular telephone network communication. All standards and/or connection types include the latest version and revision of the standard and/or connection type as of the filing date of this application.

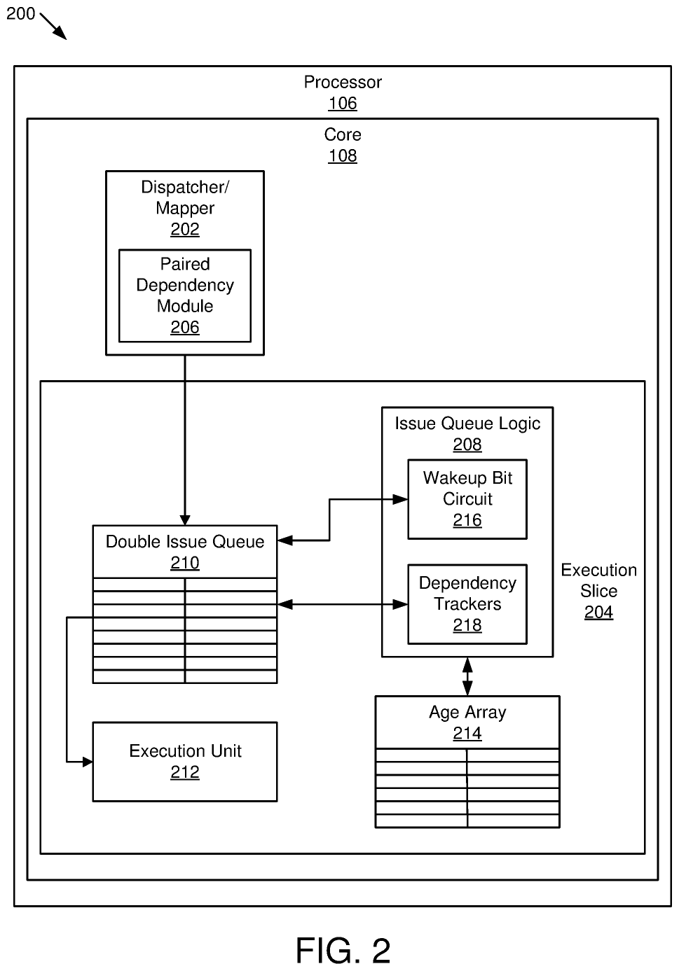

FIG. 2 is a schematic block diagram illustrating one embodiment of an apparatus 200 for back-to-back wakeup and issue of paired instructions. The apparatus 200 includes a dispatcher/mapper 202 and an execution slice 204 of a core 108 of a processor 106 of the computing device 104. The dispatcher/mapper 202 includes a paired dependency module 206. The execution slice 204 includes issue queue logic 208, a double issue queue 210, an execution unit 212, and an age array 214. The issue queue logic 208 also includes a wakeup bit circuit 216 and dependency trackers 218.

The dispatcher/mapper 202 determines whether or not to pair two compatible instructions issued from the dispatcher/mapper 202. The dispatcher/mapper 202, in the depicted embodiment, is located in a core 108, but may also be located in the processor 106 and may issue instructions to one or more cores 108. The dispatcher/mapper 202 typically issues instructions for processing by an execution slice 204 of a core 108. The processor 106 may be a multi-slice processor that includes multiple execution slices 204. An execution slice 204, in some embodiments, is a collection of hardware components and circuits configured to support execution of instructions, including elements not shown in FIG. 2, such as general-purpose registers, a history buffer, an arithmetic logic unit (including a vector scalar unit, a floating point unit, and others), etc.

Typically, each core 108 includes more than one execution slice 204. For example, a core 108 may include four execution slices 204. Execution slices 204 are one method of parallel processing of instructions and the dispatcher/mapper 202, in some embodiments, determines which execution slice 204 executes an instruction or a group of instructions. The term ‘multi-slice’ as used herein refers to a processor 106 having a plurality of similar or identical sets of components, where each set may operate independently of all the other sets or in concert with the one or more of the other sets. Each execution slice 204 may be associated with a single load/store slice to form a single processor slice, and multiple processor slices may be configured to operate together. In other embodiments, a core 108 may not include execution slices 204 and instead the double issue queue 210, execution unit 212, issue queue logic 208, dependency trackers 218, etc. are in the core 108 or in a simpler processor 106 where a processor 106 is not split into cores 108. The dispatcher/mapper 202 is typically two separate devices and is depicted as one device herein for convenience.

The dispatcher of the dispatcher/mapper 202 receives instructions from an instruction cache or other source and dispatches the instructions among execution slices 204. The instructions from the instruction cache may correspond to software written by a user and compiled for the processor 106. An instruction, in some embodiments, is a low-level or assembly-level instruction that may be 32 bits, 64 bits, etc. Other bits may be added to an instruction before processing for tracking, for adding information, for tracking readiness of an instruction, etc. Instructions are executed by various logic hardware to perform various functions, such as addition, subtraction, comparison, and other logical operations. Often, results of a logical operation are stored in one or more registers. An instruction may require results of one or more logical operations prior to execution. For example, an instruction may add two or three numbers where the numbers or operands to be added are the output of logical operations. Thus, an instruction may be dependent on completion of one or more other logical operations.

The dispatcher of the dispatcher/mapper 202 may refer to a dispatch network that includes multiple elements. One such element may perform instruction fusing using the received instructions. A fused instruction is an instruction that has been generated from multiple computer instructions. A fused instruction may be a combination of two instructions in which one instruction is dependent upon the other instruction. Fused instructions may be two instructions placed together to be executed together (e.g., in parallel, during the same cycle). One fused instruction may occupy a half entry or one full entry in a double issue queue 210.

The dispatcher of the dispatcher/mapper 202 may also pair instructions together for execution as paired instructions. Paired instructions are two or more instructions that may be placed in the same entry in the double issue queue 210. Paired instructions may also be executed in parallel (e.g., together during the same cycle). Instructions may be paired if executing both instructions would consume less than a maximum available number of execution unit resources. For example, two instructions may be paired if the total operands between the two instructions is less than (or equal to) the number of available read ports. Paired instruction may, if necessary, be dispatched and issued separately.

In some embodiments, a paired instruction may include an instruction that is dependent on results of the other instruction of the pair. For example, an instruction may add two numbers where one of the numbers is the result of the other instruction of the pair. In this instance, the instruction providing results executes may be called the “older” instruction and executes before the other “younger” instruction. As used herein, an older instruction and a younger instruction are paired in the double issue queue 210 where the older instruction is a dependent source for the younger instruction. Note that the younger instruction may also have other dependent sources. For example, where the younger instruction adds three numbers, one of the numbers is the result of the older instruction and the other two number to be added may be results of other dependent sources or one or both of the other numbers may be available when the dispatcher/mapper 202 pairs the older instruction with the younger instruction and places the paired instructions in the double issue queue 210.

In one embodiment, the mapper of the dispatcher/mapper 202 is located in an execution slice 204. In other embodiments, the mapper is located in a core 108 or in the processor 106 along with the dispatcher of the dispatcher/mapper 202. The mapper of the dispatcher/mapper 202 tracks the instructions as the instructions move through the execution slice 204. The mapper may read the source and destination of each instruction and determine the location of the source and destination in a data register file.

The mapper, in some embodiments, determines source dependencies. For example, for an add instruction with three operands, the mapper may determine that one source is ready at the time the mapper is evaluating instructions for dependencies. A source, as used herein is a logical operation that results in data being stored in a register, queue, etc. once an instruction has executed as part of the logical operation where data resulting from the execution is an operand for an instruction being written to the double issue queue 210. A logical operation of adding three numbers requires three sources. If the sources are not ready when the addition instruction send by the dispatcher/mapper 202, each source that is not ready is a dependent source for the addition instruction creating a source dependency. The issue queue logic 208 keeps track of the source dependencies for each instruction issued by the dispatcher/mapper 202 to be able to wait until results from the dependent sources are ready.

The dispatcher/mapper 202 places instructions in a double issue queue 210, which is sized for paired instructions. Pairing two instructions in a double issue queue 210 is more efficient than placing instructions in a typical single issue queue because paired instructions can use same resources and can occupy less space. The double issue queue 210 is an issue queue with entries capable of storing at least two instructions per entry. The double issue queue 210 may be two or more queues with corresponding sub-entries, with each sub-entry in each queue having corresponding sub-entries in each other queue, and with each group of corresponding sub-entries making up one entry in the double issue queue. Each entry in the double issue queue 210 is capable of storing in a row two fused instructions, two paired instructions, or two individual instructions. Individual instructions are non-fused, non-paired instructions placed independently into the double issue queue 210. As used herein, the term “half” refers to a portion or sub-entry of an entry in the double issue queue 210 and does not limit the number of portions or sub-entries in each entry.

In some embodiments, the execution slice includes an age array 214 that tracks an age of each instruction in the double issue queue 210. A row of the age array 214 may be used to track the age of one instruction, a fused instruction and/or two paired instructions in the double issue queue 210. For example, the age array 214 may include an even age array and an odd age array or may be an array with each row split into two halves and each side of the age array 214 may correspond to each side of the double issue queue 210 and each row of the age array 214 may correspond to each row of the double issue queue 210. The issue queue logic 208 may use information from the age array 214 along with dependency information to determine when to send an instruction to the execution unit 212.

The age, in one embodiment, is a timestamp of when one or two instructions were placed in a row of the double issue queue 210. In other embodiments, two instructions in a row of the double issue queue 210 may have different ages. Other embodiments of the age may include a count from an execution cycle counter or other means of tracking age of an instruction.

The issue queue logic 208 may include one or more dependency trackers 218. Each dependency tracker 218 keeps track of a source dependency. In other embodiments, the dependency trackers 218 are in an execution slice 204 and may not be considered part of the issue queue logic 208. For example, when the dispatcher/mapper 202 determine that an instruction includes one or more operands and data for an operand is not available at the time the instruction is placed in the double issue queue 210, the situation is termed herein a “source dependency” and a dependency tracker 218 monitors the source dependency by monitoring a dependent source to determine when data from the dependent source is available. Typically, for an instruction each source dependency is assigned a dependency tracker 218. The number of possible source dependencies for an instruction typically depends on the architecture and/or operating system of the computing device 104. For example, the PowerPC™ architecture has up to three operands per instruction with a potential of three source dependencies for an instruction mapped to an issue queue. Other architectures may have more or less operands, and thus more or less potential source dependencies.

The dependency trackers 218, in some embodiments, work in conjunction with dependency information in the double issue queue 210. A portion of a row of the double issue queue 210 may be used to track source dependencies of one instruction, a fused instruction, two fused instructions and/or two paired instructions in the row of the double issue queue 210. A row of the double issue queue 210 may include source dependency information, an identifier for the row of the double issue queue 210, valid bits, etc. along with one or two corresponding instructions. For example, a row of the double issue queue 210 may include source dependency information for each available dependency tracker 218. Bits allocated for tracking a source dependency may be called a dependency lane. Not all dependency lanes and/or dependency trackers 218 may be used for every instruction. One or more dependency lanes/dependency trackers 218 may be unused for an instruction.

The dependency information may include an address or pointer information for a data register file where the source information of a source dependency is stored after completion of a logical operation of the dependent source. The source dependency information may also include a wakeup bit where the wakeup bit is changed in response to the corresponding dependency tracker 218 determining that data from tracked dependent source is available. For example, the dependency tracker 218 may set the wakeup bit when the dependent source data is available.

In some instances, an instruction may include less operands than available dependency trackers 218. In other instances, some of the operands of an instruction may be available when the instruction(s) are placed in the double issue queue 210. A wakeup bit or other bit for a dependency lane may be used to signal the issue queue logic 208 and/or dependency tracker 218 that a source is available at the time the instruction is posted to the double issue queue 210 or that the instruction requires less operands than the total number of dependency trackers 218. For example, an add operation may require two operands while a total of three operands may be available so one operand is unused. The wakeup bit may be used to signal the issue queue logic 208 to ignore a dependency lane associated with an unused operand or a source that is available when the instruction is posted to the double issue queue 210. The wakeup bit may also be used to disable the dependency tracker 218 corresponding to the unused dependency lane. In other embodiments, the issue queue logic 208 may set a wakeup bit of an unused dependency lane. One of skill in the art will recognize other information to be tracked in the double issue queue 210 and other formatting options for bits in the double issue queue 210.

In some embodiments, the double issue queue 210 may include two non-paired instructions in a single row. Such an arrangement requires a number of dependency trackers 218 equal to twice the maximum number of potential source dependencies for a single instruction. For example, where there are three possible source dependencies for a single instruction, a double issue queue 210 with two non-paired instructions would require six dependency trackers 218.

Where an older instruction is a dependent source of a younger instruction, a typical dependency tracker 218 monitors a register where results of the older instruction will be stored and when the results appear in the register the dependency tracker 218 sets a wakeup bit of the younger instruction, which may then issue if other source dependencies for the younger instructions are resolved. Typically, issuance of the younger instruction and the older instruction are separated by one or two clock cycles or more. A more efficient operation would be to issue the younger instruction in the next clock cycle after issuance of the older instruction in situations where the younger instruction is not waiting for other source dependencies to resolve.

The dispatcher/mapper 202 includes a paired dependency module 206 and the issue queue logic 208 includes a wakeup bit circuit 216, which work together to issue a younger instruction in a next clock cycle after a paired older instruction where the younger instruction is not waiting for resolution of other source dependencies. The paired dependency module 206 identifies that a dependent source of a younger instruction is a result of an older instruction. The older instruction and the younger instruction are paired instructions in a double issue queue 210 of a processor 106. For example, the older and younger instructions may be paired by the dispatcher based on the younger instruction being dependent on the older instruction.

The wakeup bit circuit 216 sets a wakeup bit corresponding to the dependent source of the younger instruction that is dependent on the results of the older instruction in response to the paired dependency module identifying that a dependent source of the younger instruction is a result of the older instruction and the older instruction has issued. The wakeup bit circuit 216 sets the wakeup bit in a same clock cycle as the older instruction issues. For example, the younger instruction may have a maximum of three source dependencies where the first dependent source of the younger instruction are the results of the older instruction. The paired dependency module 206 identifies to the wakeup bit circuit 216 that the first dependent source of the younger instruction corresponds to the results of the older instruction. When the older instruction issues, the wakeup bit circuit 216 sets a wakeup bit of the younger instruction corresponding to monitoring of the first dependent source.

If the issue queue logic 208 and the dependency trackers 218 for the second and third dependent sources of the younger instruction are not waiting for dependent sources, the younger instruction issues in a clock cycle immediately after issuance of the older instruction. Beneficially, the paired dependency module 206 and the wakeup bit circuit 216 work together to bypass the dependency trackers 218 to issue the younger instruction right after the older instruction instead of waiting one or more clock cycles for the dependency trackers 218 to identify that results of the older instruction are available.

In some embodiments, the double issue queue 210 includes a plurality of source wakeup selection bits. Each source wakeup selection bit corresponds to an available dependent source of the younger instruction. The double issue queue 210 also includes a plurality of wakeup bits. Each wakeup bit also corresponds to an available dependent source of the younger instruction.

In some embodiments, the paired dependency module 206 identifies that a dependent source of a younger instruction is a result of an older instruction by identifying which dependent source of the available dependent sources of the younger instruction is dependent on the results of execution of the older instruction and then sets a source wakeup selection bit of the plurality of source wakeup bits corresponding to the dependent source of the younger instruction. The wakeup bit circuit 216 then sets the wakeup bit corresponding to the dependent source of the younger instruction that is dependent on the results of the older instruction in response to the source wakeup selection bit corresponding to the dependent source of the younger instruction being set and the older instruction being issued.

In some embodiments, the wakeup bit circuit 216 sets a wakeup bit corresponding to a dependent source of the younger instruction in response to either the paired dependency module identifying that the dependent source of the younger instruction is a result of the older instruction and the older instruction being issued or a dependency tracker 218 identifying that results a dependent source corresponding to the dependent source wakeup bit of the younger instruction are available.

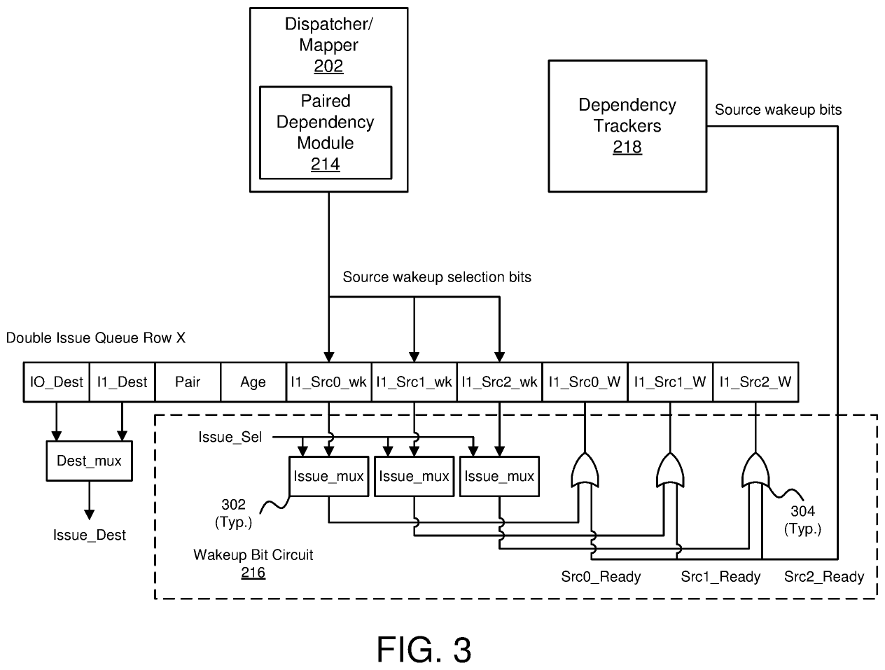

FIG. 3 is a schematic block diagram illustrating a portion of a row X of a double issue queue 210 with paired instructions and associated circuitry for back-to-back wakeup and issue of the paired instructions. The double issue queue 210 include a source wakeup selection bit for each possible dependent source of the younger instruction in addition to wakeup bits for the available dependent sources. In the embodiment depicted in FIG. 3, the younger instruction tracks a maximum of three source dependencies so there are three source wakeup selection bits I1_Src0_wk, I1_Src1_wk and I1_Src2_wk. The double issue queue also include wakeup bits I1_Src0_W, I1_Src1_W and I1_Src2_W. Also depicted are destination locations for results of the older instruction (“I0”) and the younger instruction (“I1”): I0_Dest and I1_Dest. The destination multiplexer Dest_mux outputs a destination Issue_Dest corresponding to which of the paired instructions is being exported to the execution unit 212. The double issue queue row X also includes a Pair bit that indicates that there are paired instructions in the row X and age bits that indicate an age of each instruction.

Note that the issue queue row X only depicts some bits of the double issue queue 210. For example, the row X of the double issue queue 210 may include the older instruction, the newer instruction, wakeup bits for the older instruction, locations in one or more registers of source dependency data for the older and younger instructions, etc.

The paired dependency module 206 identifies which dependent source of a younger instruction is the results of the older instruction. For example, if dependent source 1 of the younger instruction I1 is linked to the results of the older instruction, the source wakeup selection bits I1_Src0_wk, I1_Src1_wk and I1_Src2_wk would be 100 respectively. If dependent source 2 of the younger instruction I1 is linked to the results of the older instruction, the source wakeup selection bits I1_Src0_wk, I1_Src1_wk and I1_Src2_wk would be 010 respectively and if dependent source 3 of the younger instruction I1 is linked to the results of the older instruction, the source wakeup selection bits I1_Src0_wk, I1_Src1_wk and I1_Src2_wk would be 001 respectively.

The source wakeup selection bits I1_Src0_wk, I1_Src1_wk and I1_Src2_wk are input into three issue multiplexers Issue_mux. If dependent source 1 of the younger instruction I1 is linked to the results of the older instruction, the first issue multiplexer will have a logic 1 at one input and the other issue multiplexers will have a logic 0 at their respective inputs. An issue selection signal Issue_Sel is input to each issue multiplexer Issue_mux. When the older instruction issues, the issue selection signal Issue_Sel will be set and the first issue multiplexer Issue_mux will have an output that goes high to set the wakeup bit I1_Src0_W of the first dependent source of the younger instruction.

If the other two wakeup bits I1_Src1_W and I1_Src2_W are set due to the second and third source dependencies of the younger command not being used, being resolved before the dispatcher pairs the instructions, or because the second and third source dependencies were resolved previously, the younger instruction issues to the execution unit 212 on a next clock cycle after the older instruction issues. The paired dependency module 206 and the wakeup bit circuit 216 act quicker than the dependency trackers 218. While issue multiplexers and OR gates are depicted in the wakeup bit circuit 216, other hardware devices may be used that perform functions similar to the issue multiplexers and the OR gates.

Note that the outputs of the issue multiplexers Issue_mux are OR'd with the outputs of the dependency trackers 218, which allows the dependency trackers 218 to set the wakeup bits I1_Src0_wk, I1_Src1_wk and I1_Src2_wk for dependent sources other than the results of the older instruction being a dependent source. In some embodiments, the older instruction also includes dependency trackers 218 but do not include OR gates or other elements of the wakeup bit circuit 216. In some embodiments, the dispatcher places the older instruction and the younger instruction on a same sides of the double issue queue 210 so that bits in the row X of the double issue queue 210 corresponding to the younger instruction are positioned to be affected by the wakeup bit circuit 216. In other embodiments, the older and younger instructions may be switched and issue multiplexers Issue_mux and OR gates are included for both instructions of the double issue queue 210.

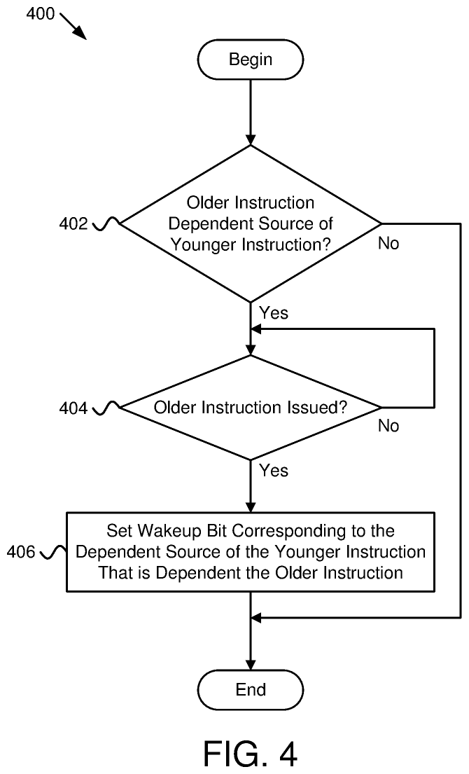

FIG. 4 is a schematic flow chart diagram illustrating one embodiment of a method 400 for back-to-back wakeup and issue of paired instructions. The method 400 begins and determines 402 if a dependent source of a younger instruction is a result of an older instruction where the older instruction and the younger instruction are paired instructions in a double issue queue 210 of a processor 106. If the method 400 determines 402 that a dependent source of a younger instruction is not a result of an older instruction, the method 400 ends. If the method 400 determines 402 that a dependent source of a younger instruction is a result of an older instruction, the method 400 determines 404 if the older instruction has been issued. If method 400 determines 404 that the older instruction has not been issued, the method 400 returns and continues to determine 404 if the older instruction has been issued. If method 400 determines 404 that the older instruction has been issued, the method 400 sets the wakeup bit corresponding to the dependent source of the younger instruction that is dependent on the results of the older instruction, and the method 400 ends. In various embodiments, the paired dependency module 206 and the wakeup bit circuit 216 perform some or all of the steps of the method 400.

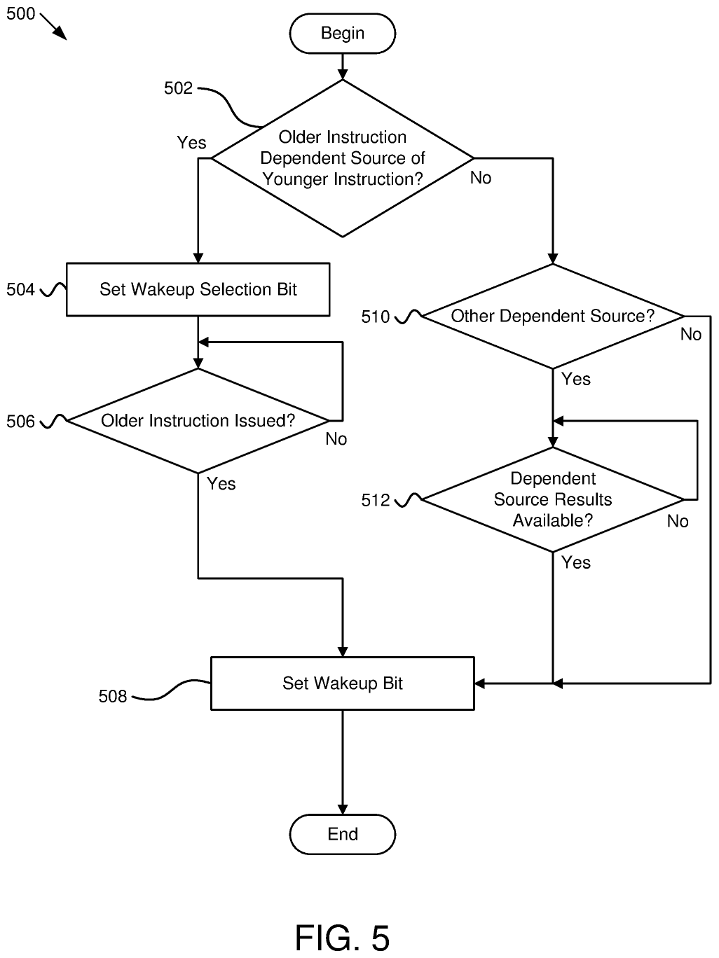

FIG. 5 is a schematic flow chart diagram illustrating one embodiment of another method 500 for back-to-back wakeup and issue of paired instructions. The method 500 begins and determines 502 if a dependent source of a younger instruction is a result of an older instruction where the older instruction and the younger instruction are paired instructions in a double issue queue 210 of a processor 106. If the method 500 determines 502 that a dependent source of a younger instruction is a result of an older instruction, the method 500 sets 504 a source wakeup selection bit of the plurality of source wakeup bits corresponding to the dependent source of the younger instruction and determines 506 determines 506 if the older instruction has been issued.

If method 500 determines 506 that the older instruction has not been issued, the method 500 returns and continues to determine 506 if the older instruction has been issued. If method 500 determines 506 that the older instruction has been issued, the method 500 sets the wakeup bit corresponding to the dependent source of the younger instruction that is dependent on the results of the older instruction, and the method 500 ends. If the method 500 determines 502 that a dependent source of a younger instruction is not a result of an older instruction, the method 500 determines 510 if the younger instruction had other dependent sources. If the method 500 determines 510 that there are there are not other dependent sources for the younger instruction, the method 500 sets 508 a corresponding wakeup bit, and the method 500 ends.

If the method 500 determines 510 that there are there are other dependent sources for the younger instruction, the method 500 determines 512 if results of the dependent sources are available. If the method 500 determines 512 that results of the dependent sources are not available, the method 500 returns and continues to determine 512 if results from the dependent sources are available. If the method 500 determines 512 that results of the dependent sources are available, the method 500 sets a corresponding wakeup bit for the younger instruction and the method 500 ends. Note that steps 510 and 512 may be duplicated to track all available dependent sources. In various embodiments, the paired dependency module 206 and the wakeup bit circuit 216 perform some or all of the steps of the method 500.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
a paired dependency module that identifies that a dependent source of a younger instruction is a result of an older instruction, the older instruction and the younger instruction comprising paired instructions in a double issue queue of a processor; and
a wakeup bit circuit that sets a wakeup bit corresponding to the dependent source of the younger instruction that is dependent on the results of the older instruction in response to the paired dependency module identifying that a dependent source of the younger instruction is a result of the older instruction and the older instruction being issued, wherein the wakeup bit circuit sets the wakeup bit in a same clock cycle as the issue of the older instruction.

2. The apparatus of claim 1, wherein the double issue queue comprises a plurality of source wakeup selection bits, each source wakeup selection bit corresponding to an available dependent source of the younger instruction, and comprises a plurality of wakeup bits, each wakeup bit corresponding to an available dependent source of the younger instruction, wherein the wakeup bit corresponding to a dependent source indicates that results of the dependent source are available.

3. The apparatus of claim 2, wherein identifying that a dependent source of a younger instruction is a result of an older instruction comprises:
identifying which dependent source of the available dependent sources of the younger instruction is dependent on the results of execution of the older instruction; and
setting a source wakeup selection bit of the plurality of source wakeup selection bits corresponding to the dependent source of the younger instruction,
wherein the wakeup bit circuit sets the wakeup bit corresponding to the dependent source of the younger instruction that is dependent on the results of the older instruction in response to the source wakeup selection bit corresponding to the dependent source of the younger instruction being set and the older instruction being issued.

4. The apparatus of claim 3, wherein the wakeup bit circuit comprises an issue multiplexer that sets the wakeup bit corresponding to the dependent source of the younger instruction that is dependent on the results of the older instruction in response to the source wakeup selection bit corresponding to the dependent source of the younger instruction being set and the results of execution of the older instruction being available.

5. The apparatus of claim 1, wherein the double issue queue comprises a plurality of wakeup bits, each wakeup bit corresponding to an available dependent source of the younger instruction, wherein the wakeup bit corresponding to a dependent source indicates that results of the dependent source are available, and wherein the wakeup bit circuit sets a wakeup bit corresponding to a dependent source of the younger instruction in response to one of:
the paired dependency module identifying that the dependent source of the younger instruction is a result of the older instruction and the older instruction being issued; and
a dependency tracker identifying that results a dependent source corresponding to the wakeup bit of the dependent source of the younger instruction are available.

6. The apparatus of claim 1, wherein the wakeup bit circuit sets the wakeup bit corresponding to the dependent source of the younger instruction that is dependent on the results of the older instruction prior to a dependency tracker setting the wakeup bit after identifying that the results of the older instruction are available.

7. The apparatus of claim 1, further comprising an execution unit that executes the older instruction in a first clock cycle and that executes the younger instruction in a second clock cycle in response to the wakeup bit circuit setting the wakeup bit corresponding to the dependent source of the younger instruction that is dependent on the results of the older instruction, wherein the second clock cycle is immediately after the first clock cycle.

8. The apparatus of claim 1, wherein the paired dependency module is part of a dispatcher, wherein the dispatcher places the paired instructions in the double issue queue.

9. A computer-implemented method comprising:
identifying that a dependent source of a younger instruction is a result of an older instruction, the older instruction and the younger instruction comprising paired instructions in a double issue queue of a processor; and
setting, in a same clock cycle as the older instruction issues, a wakeup bit corresponding to the dependent source of the younger instruction that is dependent on the results of the older instruction in response to identifying that a dependent source of the younger instruction is a result of the older instruction and the older instruction being issued.

10. The computer-implemented method of claim 9, wherein the double issue queue comprises a plurality of source wakeup selection bits, each source wakeup selection bit corresponding to an available dependent source of the younger instruction, and comprises a plurality of wakeup bits, each wakeup bit corresponding to an available dependent source of the younger instruction, wherein the wakeup bit corresponding to a dependent source indicates that results of the dependent source are available.

11. The computer-implemented method of claim 10, wherein identifying that a dependent source of a younger instruction is a result of an older instruction comprises:
identifying which dependent source of the available dependent sources of the younger instruction is dependent on the results of execution of the older instruction; and
setting a source wakeup selection bit of the plurality of source wakeup selection bits corresponding to the dependent source of the younger instruction,
wherein setting the wakeup bit corresponding to the dependent source of the younger instruction that is dependent on the results of the older instruction in response to the source wakeup selection bit corresponding to the dependent source of the younger instruction being set and the older instruction being issued.

12. The computer-implemented method of claim 9, wherein the double issue queue comprises a plurality of wakeup bits, each wakeup bit corresponding to an available dependent source of the younger instruction and wherein setting a wakeup bit corresponding to a dependent source of the younger instruction is in response to one of:
identifying that the dependent source of the younger instruction is a result of the older instruction and the older instruction being issued; and
identifying that results a dependent source corresponding to the dependent source wakeup bit of the younger instruction are available.

13. The computer-implemented method of claim 9, wherein setting the wakeup bit corresponding to the dependent source of the younger instruction that is dependent on the results of the older instruction occurs prior to a dependency tracker setting the wakeup bit after identifying that the results of the older instruction are available.

14. The computer-implemented method of claim 9, further comprising executing the older instruction in a first clock cycle and executing the younger instruction in a second clock cycle in response to setting the wakeup bit corresponding to the dependent source of the younger instruction that is dependent on the results of the older instruction, wherein the second clock cycle is immediately after the first clock cycle.

15. The computer-implemented method of claim 9, wherein identifying that a dependent source of a younger instruction is a result of an older instruction occurs in one or more of a dispatcher and a mapper, wherein the dispatcher places the paired instructions in the double issue queue and the mapper maps each instruction with a register that stores results of the instruction.

16. A processor comprising:
a double issue queue sized for paired instructions, each set of paired instructions comprising an older instruction and a younger instruction, the double issue queue comprising:
a plurality of source wakeup selection bits, each source wakeup selection bit corresponding to an available dependent source of the younger instruction; and
a plurality of wakeup bits, each wakeup bit corresponding to an available dependent source of the younger instruction, wherein the wakeup bit corresponding to a dependent source indicates that results of the dependent source are available;
a dispatcher that:
identifies that a dependent source of the younger instruction is a result of the older instruction;
identifies which dependent source of the available dependent sources of the younger instruction is dependent on the results of execution of the older instruction; and
sets a source wakeup selection bit of the plurality of source wakeup selection bits corresponding to the dependent source of the younger instruction; and
an issue multiplexer corresponding to each dependent source of the younger instruction, wherein the issue multiplexer corresponding to the dependent source of the younger instruction that is a dependent source of the older instruction sets the wakeup bit corresponding to the dependent source of the younger instruction that is dependent on the results of the older instruction in response to the source wakeup selection bit corresponding to the dependent source of the younger instruction that is a result of the older instruction being set and the older instruction being issued.

17. The processor of claim 16, further comprising an OR gate for each wakeup bit of the younger instruction, wherein the OR gate of a wakeup bit sets the wakeup bit in response to one of:
a dependency tracker corresponding to the wakeup bit identifying that results of a dependent source corresponding to the wakeup bit of the younger instruction are available; and
the issue multiplexer of the dependent source identifying that the source wakeup selection bit corresponding to the dependent source of the younger instruction that is a result of the older instruction being set and the older instruction being issued.

18. The processor of claim 16, wherein the issue multiplexer corresponding to the dependent source of the younger instruction that is a result of the older instruction sets the wakeup bit corresponding to the dependent source of the younger instruction that is dependent on the results of the older instruction prior to a dependency tracker setting the wakeup bit after identifying that the results of the older instruction are available.

19. The processor of claim 16, further comprising an execution unit that executes the older instruction in a first clock cycle and that executes the younger instruction in a second clock cycle in response to the issue multiplexer setting the wakeup bit corresponding to the dependent source of the younger instruction that is dependent on the results of the older instruction, wherein the second clock cycle is immediately after the first clock cycle.

20. The processor of claim 16, further comprising a computing device, the computing device includes the processor.
